(19) United States
(12) Patent Application Publication
(10) Pub. No.: US 2010/0126752 A1
(43) Pub. Date: May 27, 2010

(54) SHIELD CONDUCTOR

(75) Inventor: Kunihiko Watanabe, Yokkaichi-shi (JP)

Correspondence Address: OLIFF & BERRIDGE, PLC, P.O. BOX 320850, ALEXANDRIA, VA, 22320-4850, US

(73) Assignees: AUTONETWORKS TECHNOLOGIES, LTD., Yokkaichi-shi, Mie (JP); SUMITOMO WIRING SYSTEMS ,LTD., Yokkaichi-shi ,Mie (JP); SUMITOMO ELECTRIC INDUSTRIES, LTD., Osaka-shi ,Osaka (JP)

(21) Appl. No.: 12/451,332

(22) PCT Filed: Aug. 25, 2008
(86) PCT No.: PCT/JP2008/065081

§ 371 Date: Nov. 6, 2009

(30) Foreign Application Priority Data
Aug. 30, 2007 (JP) 2007-223841

(51) Int. Cl. H01B 9/02

(52) U.S. Cl. 174/102 D

(57) ABSTRACT

This invention provides a shield conductor having heat dissipation property and flexibility. The shield conductor comprises: multiple wires; a shielding layer enwrapping the outer circumference of the wires while having flexibility; a sleeve pipe having multiple first housing members that are arranged in a row in a direction orthogonal to the axial direction of the wires and separately house the wires enwrapped by the shielding layer; a connecting member having multiple second housing members that are connected with each first housing member in the sleeve pipe and separately house the wires enwrapped by the shielding layer, while having a third housing member that is communicated with each second housing member and collectively houses the wires enwrapped by the shielding layer, and a corrugated tube connected with the third housing member in the connecting member and collectively housing the wires enwrapped by the shielding layer.

### TECHNICAL FIELD

The present invention relates to a shield conductor.

Conventionally, a shield conductor disclosed in Patent Literature 1 which is mounted in an electric vehicle and electrically connects between equipments such as an inverter and a motor has been well-known. This shield conductor comprises multiple wires, a braided wire enwrapping the wires, and a corrugated tube enwrapping the wires and the braided wire. With the above configuration, the shield conductor can obtain flexibility in its entirety. And as a result, the shield conductor can be bent at a relatively small radius of curvature, and thereby being easily arranged even in a relatively narrow space such as an engine room.

[Patent literature 1]: Japanese Unexamined Patent Publication No. 2004-172476

### DISCLOSURE OF THE INVENTION

However, in the above configuration where the wires are enwrapped by the corrugated tube, the radiation performance of the heat radiation from the wires is a problem. In short, according to the above configuration, an air layer exists between the wire and the braided wire, and between the braided wire and the corrugated tube. The heat conductivity of the air is relatively low, and this air layer therefore disturbs the heat radiation to the outside. As a result, the heat generated from the wires remains inside of the corrugated tube, and might cause a temperature rise of the wires.

In a case where the upper limit of the temperature rise value of the wires has already been decided, the heating value at the time of feeding electricity may be lowered by enlarging the diameter of the wire. However, this method causes the enlargement of the entire shield conductor, and cannot therefore be employed.

Considering the foregoing, there may be considered a method of enwrapping the outer circumference of multiple wires by a shielding layer, and housing the wires in a sleeve pipe, in which housing members capable of separately housing the wires enwrapped by the shielding layer are provided in a row. According to this configuration, the inner surface of the housing member of the sleeve pipe tightly adheres to the shielding layer, and moreover, the inner surface of the shielding layer tightly adheres to the wires. This enables heat generated from the wires to be transmitted from the wires to the sleeve pipe through the shielding layer, and then released from the sleeve pipe to the outside of the shield conductor. Accordingly, improved heat dissipation property of the shield conductor can be expected.

However, with the configuration of the sleeve pipe for housing the wires in a row, it is difficult to provide flexibility to the shield conductor. Considering the foregoing, there may be considered a method of connecting the sleeve pipe and the corrugated tube, and in a relatively large space, using the sleeve pipe, while in a relatively narrow space, using the corrugated tube.

However, the sleeve pipe, which has the housing members provided in a row for housing the wires, has a complicated shape and is therefore difficult to be rigidly fixed with the corrugated tube with a caulking ring.

This invention has been completed based on the above circumstances, and its purpose is to provide a shield conductor having heat dissipation property and flexibility.

The present invention relates to a shield conductor comprising: multiple wires; a shielding layer enwrapping the outer circumference of the wires while having flexibility; a sleeve pipe having multiple first housing members that are arranged in a row in the direction orthogonal to the axial direction of the wires and separately house the wires enwrapped by the shielding layer; a connecting member having multiple second housing members that are connected with each first housing member in the sleeve pipe and separately house the wires enwrapped by the shielding layer, while having a third housing member that is communicated with each second housing member and collectively houses the wires enwrapped by the shielding layer; and a corrugated tube connected with the third housing member in the connecting member and collectively housing the wires enwrapped by the shielding layer.

According to the present invention, using the connecting member allows the sleeve pipe provided with the housing members arranged in a row for housing the wires and the corrugated tube to be easily connected. This enables the wires and the shielding layer housed inside of the sleeve pipe to be arranged in a relatively large space, while in a relatively narrow space, enabling the wires and the shielding layer housed inside of the corrugated tube to be arranged. Consequently, the heat dissipation property of the shield conductor in a part using the sleeve pipe can be improved, while in a part using the corrugated tube, flexibility can be provided to the shield conductor.

### BRIEF DESCRIPTION OF THE DRAWINGS

FIG. 1 is a cross-sectional view showing a shield conductor according to the present embodiment;

FIG. 2 is a cross-sectional view taken along a line A-A in FIG. 1;

FIG. 3 is a cross-sectional view taken along a line B-B in FIG. 1;

FIG. 4 is a perspective view of a sleeve pipe;

FIG. 5 is a perspective view of a plate member;

FIG. 6 is an elevation view of the plate member;

FIG. 7 is a cross-sectional view showing a manufacturing process of the sleeve pipe;

FIG. 8 is a cross-sectional view showing the sleeve pipe;

FIG. 9A is a cross-sectional view showing a state before a pin is inserted into an insertion hole;

FIG. 9B is a cross-sectional view showing a state of the pin on the way to be inserted into an insertion hole;

FIG. 9C is a cross-sectional view showing a state after the pin has been inserted into an insertion hole;

FIG. 10 is a plain view of a connecting member in a state connected with the sleeve pipe and the corrugated tube;

FIG. 11 is an exploded perspective view showing a half-split body;

FIG. 12 is a plain view showing the half-split body;

FIG. 13 is a cross-sectional view showing a connecting structure between the corrugated tube and the half-split body;

FIG. 14 is a perspective view of a bag member;

FIG. 15 is a cross-sectional view of the manufacturing process of the shield conductor, showing a state of the sleeve pipe fitted to the wire and the braided wire;

FIG. 16 is a cross-sectional view of a fitted-state of the bag member;

FIG. 17 is a cross-sectional view taken along a line C-C in FIG. 16;

FIG. 18 is a cross-sectional view showing the fitting process of the corrugated tube;

FIG. 19 is a cross-sectional view showing a fitted-state of the corrugated tube;

FIG. 20 is a cross-sectional view showing the fitting process of the half-split body.

### DESCRIPTION OF SYMBOLS

10 . . . shield conductor
11 . . . sleeve pipe
12 . . . braided wire (shielding layer)
13 . . . wire
16 . . . first housing member
40 . . . connecting member
41 . . . corrugated tube
42 . . . second housing member
44 . . . third housing member
49 . . . half-split body
50 . . . first arcuate part
51 . . . second arcuate part
53 . . . bag member
54 . . . heat conductive material

### BEST MODE FOR CARRYING OUT THE INVENTION

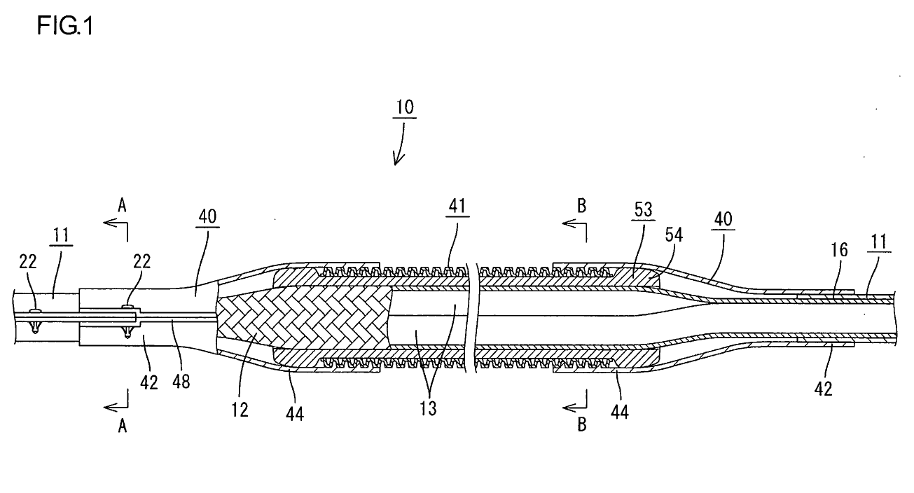

In reference to FIGS. 1 to 20, one embodiment in which the present invention is applied to a shield conductor 10 is described. The present embodiment is mounted in, for example, a vehicle (not shown) such as an electric vehicle and a hybrid vehicle, and electrically connects between equipments such as a battery (not shown), an inverter device (not shown), and a motor (not shown). The shield conductor 10 is fitted to the vehicle by a holding member (not shown) such as, for example, a clamp. As shown in FIG. 1, the shield conductor 10 according to the present embodiment is constituted by enwrapping the outer circumference of multiple (three in the present embodiment) of wires 13 by a braided wire 12 (corresponding to a shielding layer), and housing the wires 13 enwrapped by the braided wire 12 inside of the sleeve pipe 11, connecting member 40, and the corrugated tube 41.

(Wire)

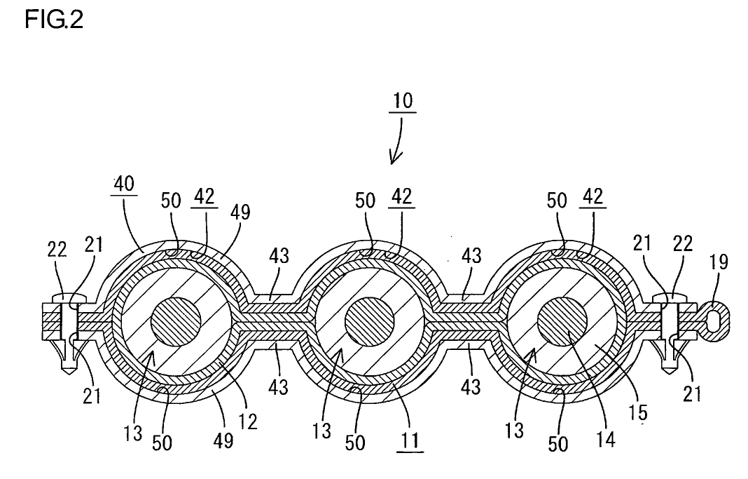

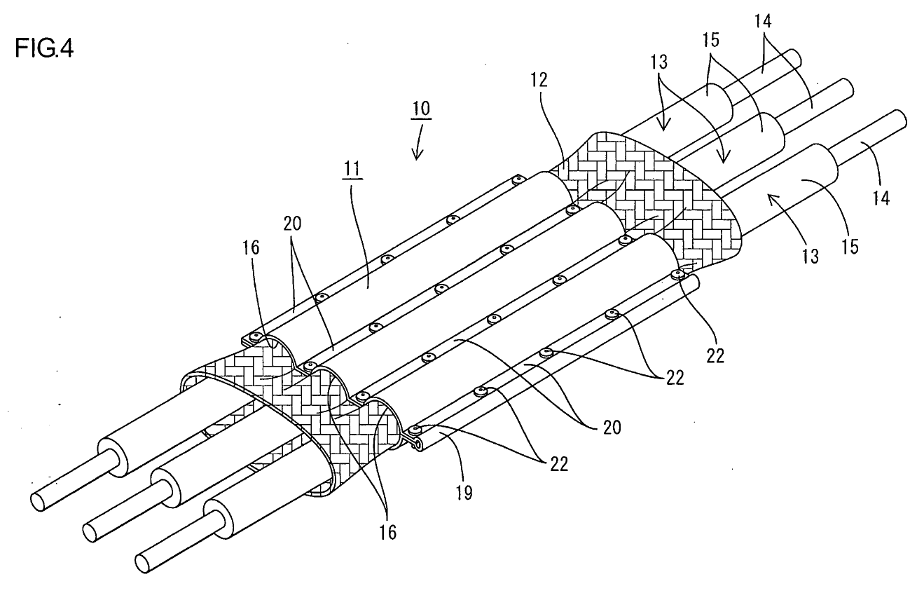

As shown in FIG. 4, the wire 13 is constituted by enwrapping the outer circumference of a core wire 14 made of metal (for example, such as aluminum alloy and copper alloy) with an insulating coating 15 made of a synthetic resin. The wire 13 according to the present embodiment is a non-shielded type. Regarding the cross-sectional shape of the wire 13, the cross-sectional shape of both the core wire 14 and the insulating coating 15 are a circular shape as shown in FIG. 2. Though not shown in details, the core wire 14 is composed of a twisted wire spirally twisting a plurality of thin wires or a rod-shaped single core wire.

(Braided Wire)

As shown in FIG. 4, the braided wire 12 forms a tubular shape as a whole. This braided wire 12 is constituted by weaving a metal thin wire into meshes. Three wires 13 are collectively enwrapped by the braided wire 12. The braided wire 12 is capable of stretching in the radial direction as well as the length direction due to the flexibility of the metal thin wire.

(Sleeve Pipe)

As shown in FIG. 1, provided in the sleeve pipe 11 are the first housing members 16, as extending in the axial direction of the wire 13 (in a direction from the left front side to the right back side in FIG. 4). Each first housing member 16 is arranged in a row in a direction perpendicular to the extending direction of the wire 13 (in a direction from the right front side to the left back side in FIG. 4) at intervals. Three wires 13 enwrapped by the braided wire 12 are separately housed in each first housing member 16 (see FIG. 2). This allows each wire 13 to be housed in the sleeve pipe 11 in a row, in a direction perpendicular to the axial direction of the wire 13 at intervals.

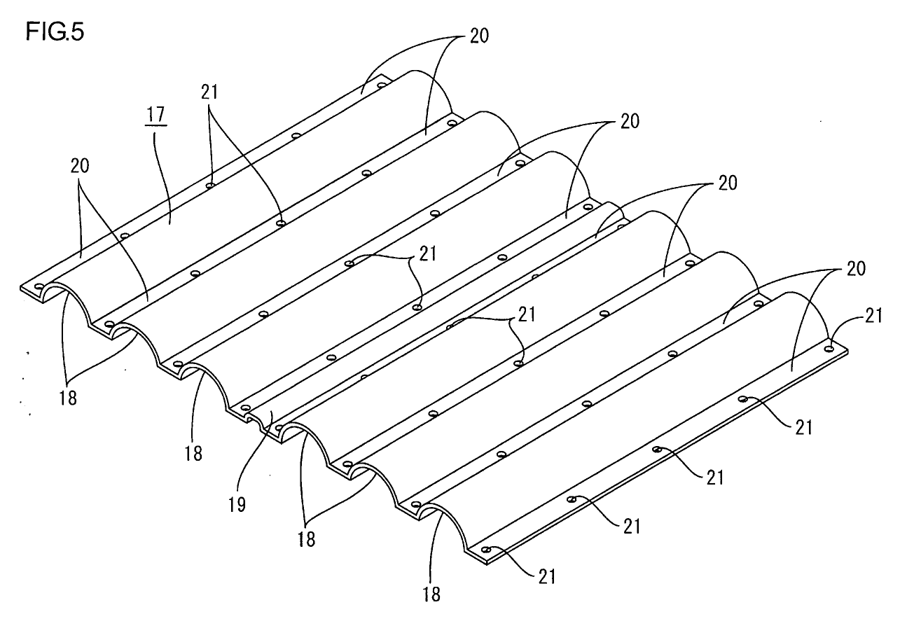

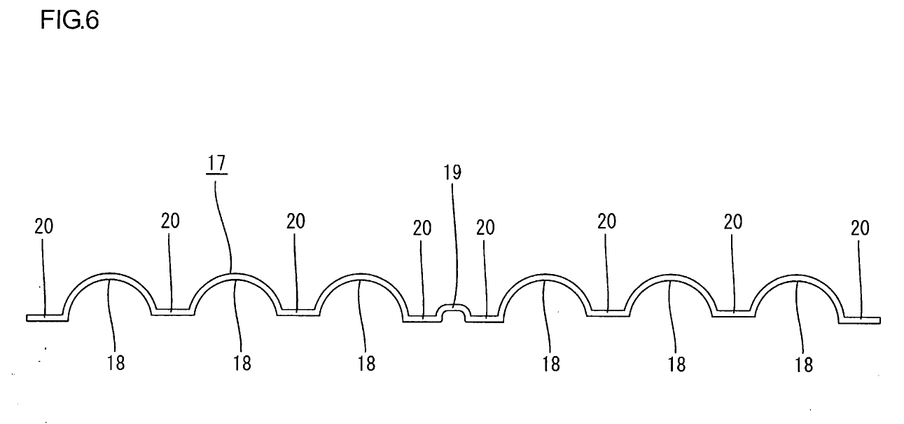

As shown in FIGS. 5 and 6, the sleeve pipe 11 is formed by folding a plate member 17 made of synthetic resin. As a synthetic resin, for example, materials relatively having rigidity, such as polyethylene, polypropylene, PET, PBT, and nylon may be used. The plate member 17 is formed by a known method (for example, extrusion). As shown in FIG. 5, formed in the plate member 17 in a row in a direction from the right front side to the left back side are six grooves 18. Each groove 18 is formed in a manner so as to extend from the left front side to the right back side in FIG. 5. As shown in FIG. 6, each groove 18 is formed in a manner so as to be recessed in some degree upwardly in FIG. 6, and its cross-sectional shape is semicircular.

In the plate member 17, a folding member 19 for folding the plate member 17 is formed in the near-center in the right and left direction in FIG. 6 in a manner so as to be recessed upwardly in FIG. 6. This folding member 19 is formed in a manner so as to extend along the extending direction of the groove 18 (in FIG. 5, from the left front side to the right back side).

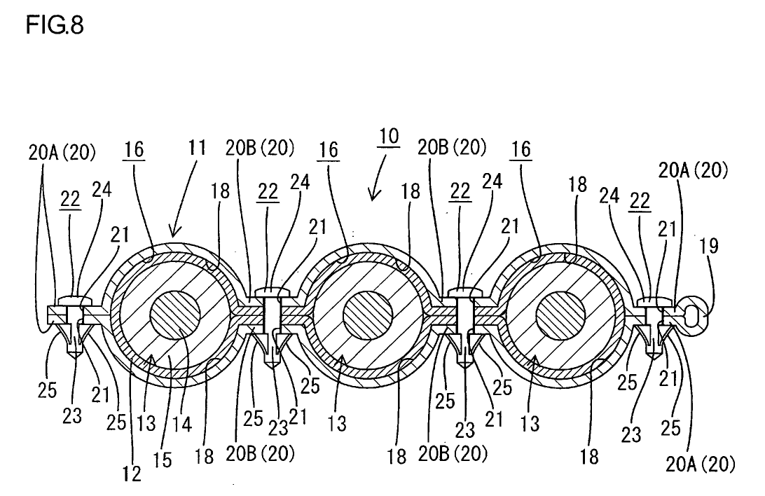

As shown in FIG. 8, each groove 18 is formed in a position opposing each other when the plate member 17 is folded at the folding member 19. Between the grooves 18 opposing each other, a spacing having a circular cross-sectional shape is formed. The wire 13 and the braided wire 12 are housed inside this spacing, and thus the above-mentioned first housing member 16 is constituted. The radius of the inner circumferential surface of the groove 18 is designed so as to be slightly smaller than the one obtained by adding the thickness of the braided wire 12 to the radius of the outer circumferential surface of the insulating coating of the wire 13.

In the sleeve pipe 11, an opposing wall 20 opposing each other is formed in both the right and left side of each first housing member 16 in FIG. 8. Among the opposing walls 20, first opposing walls 20A provided in the places closest to the right and left end of the sleeve pipe 11 in FIG. 8 abut each other from above and below. In addition, among the opposing walls 20, second opposing walls 20B provided near the center in the right and left direction of the sleeve pipe 11 in FIG. 8 oppose each other with a spacing therebetween, in a holding state of the braided wire 12 in between the opposing walls 20. This spacing is designed so as to be slightly smaller than twice of the thickness of the braided wire 12.

As shown in FIG. 5, multiple insertion holes 21 are formed in the opposing wall 20 along the extending direction of the first housing member 16 in a row at intervals, and penetrate through the opposing wall 20. As shown in FIG. 8, the insertion hole 21 is formed in a position such that, when the plate member 17 is folded at the folding member 19, the insertion hole 21 formed in the opposing wall 20 positioned upper side and the insertion hole formed in the opposing wall 20 positioned in the lower side correspond each other. This allows each insertion hole 21 to communicate vertically in FIG. 8, when the plate member 17 is folded at the folding member 19. Inserted vertically into this insertion hole 21 is a pin 22 made of synthetic resin. Though described later in details, this pin 22 presses the inner circumference of the first housing member toward the outer circumference of the wire 13. Additionally, the pin 22 inserted into the insertion hole 21 in near the center in the right and left direction in FIG. 8 penetrates through gaps in the metal thin wires composing the braided wire 12.

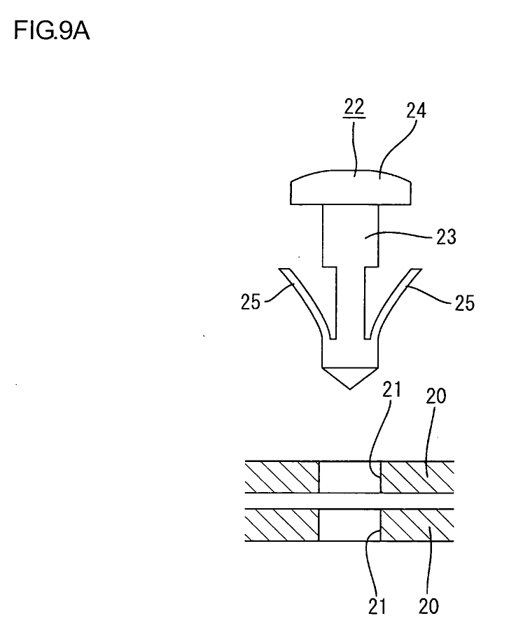

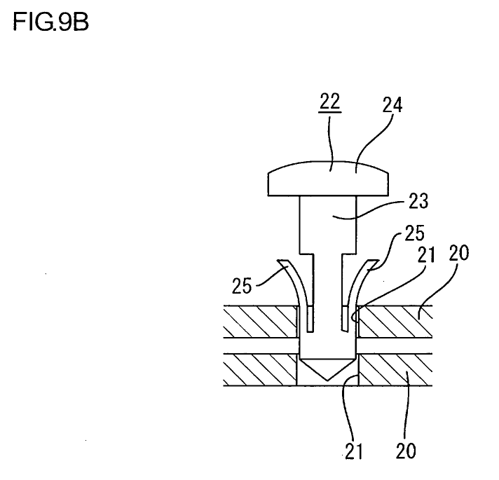

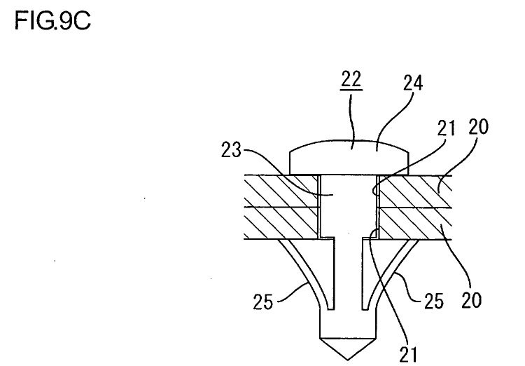

As shown in FIG. 9A, the pin 22 comprises an shaft part 23 extending up and down in FIG. 9A and a flat part 24 positioned in the upper end of the shaft part 23 and forming a flat shape of a diameter larger than that of the shaft part 23. In the shaft part 23, from the position close to the lower end thereof, a pair of fall-out preventing pieces 25 is provided so as to extend diagonally upward left and upward right. The fall-out preventing piece 25 is capable of elastic deformation.

The shaft part 23 of the pin 22 inserted into the insertion hole 21 that is positioned near the both right and left ends of the sleeve pipe 11 in FIG. 8 is designed so as to have a shorter height than that of the shaft part 23 of the pin 22 inserted into the insertion hole 21 that is positioned near the center in the right and left direction of the sleeve pipe 11.

As shown in FIG. 8, with the pin inserted into the insertion hole 21 from up to down, the opposing walls 20 each other are held between the bottom surface of the flat part 24 of the pin 22 and the upper end of the fall-out preventing piece 25, and thereby fixed in a vertically pressed-state by elastic repulsive force of the fall-out preventing piece 25. This causes the groove 18 positioned upper side in FIG. 8 to be pressed downwardly and forced on the upper half of the outer circumference of the wire 13. On the other hand, the groove 18 positioned lower side in FIG. 8 is pressed upwardly and forced onto the lower half of the outer circumference of the wire 13. With this configuration, the inner circumference of the first housing member 16 constituted by the groove 18 is pressed toward the outer circumference of the wire 13. Accordingly, the braided wire 12 is held between the inner circumference of the first housing member 16 and the outer circumference of the wire 13, and thus, the inner circumference of the first housing member 16 adheres tightly to the braided wire 12, while the braided wire 12 adheres tightly to the outer circumference of the wire 13.

(Connecting Member)

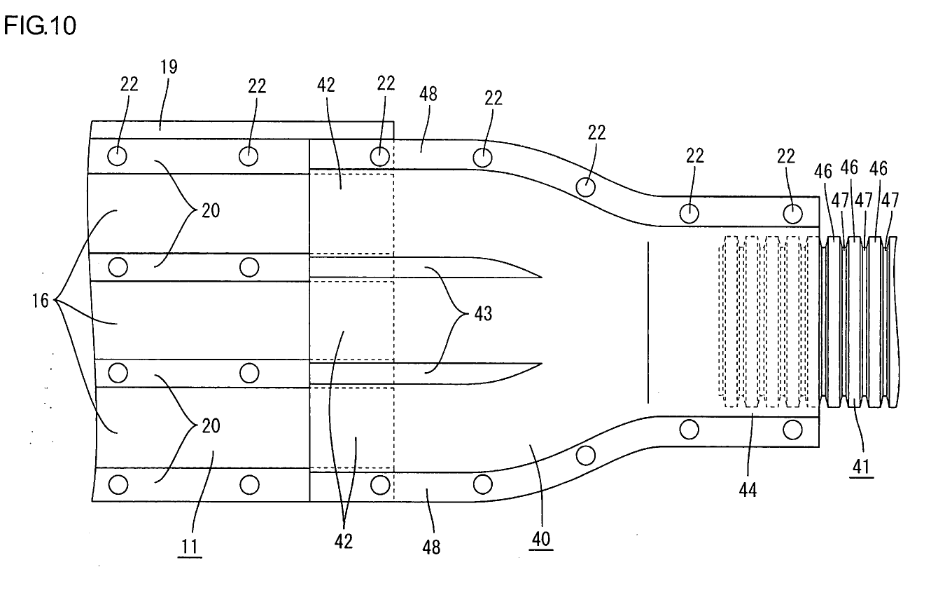

As shown in FIGS. 1 and 10, one end of the connecting member 40 is connected with the end of the sleeve pipe 11, while the other end is connected with the corrugated tube 41. Formed in the end of the connecting member 40 in the side of the sleeve pipe 11 are three second housing members 42 in positions corresponding to three first housing members 16 in the sleeve pipe 11. As shown in FIG. 2, the internal diameter of the second housing member 42 is designed so as to be nearly the same as the external diameter of the first housing member 16. Each second housing member 42 is connected by being externally fitted onto the outer circumference of each corresponding first housing member 16. As shown in FIG. 2, the wires 13 enwrapped by the braided wire 12 are separately housed inside of each second housing member 42. Two joint parts 43 are formed between the adjacent second housing members 42. The insertion hole 21 for inserting the above-mentioned pin 22 is formed in each joint part 43 so as to penetrate through the connecting member 40.

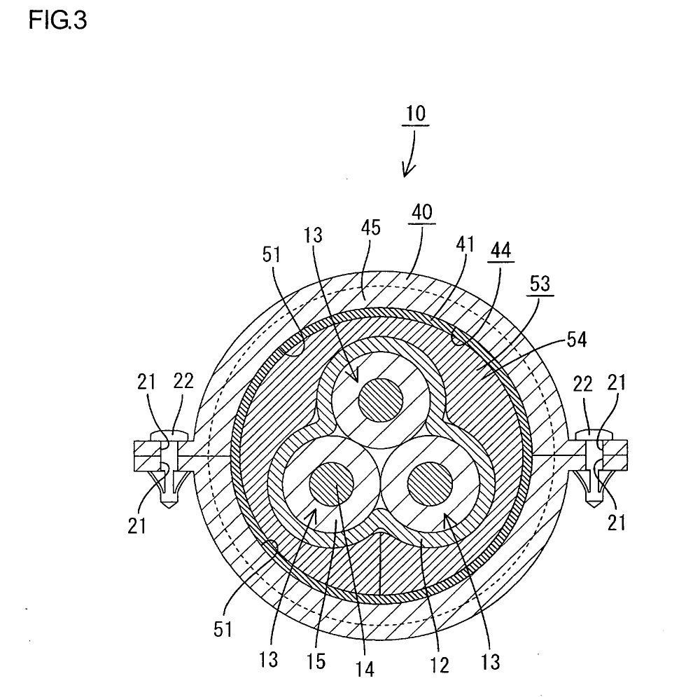

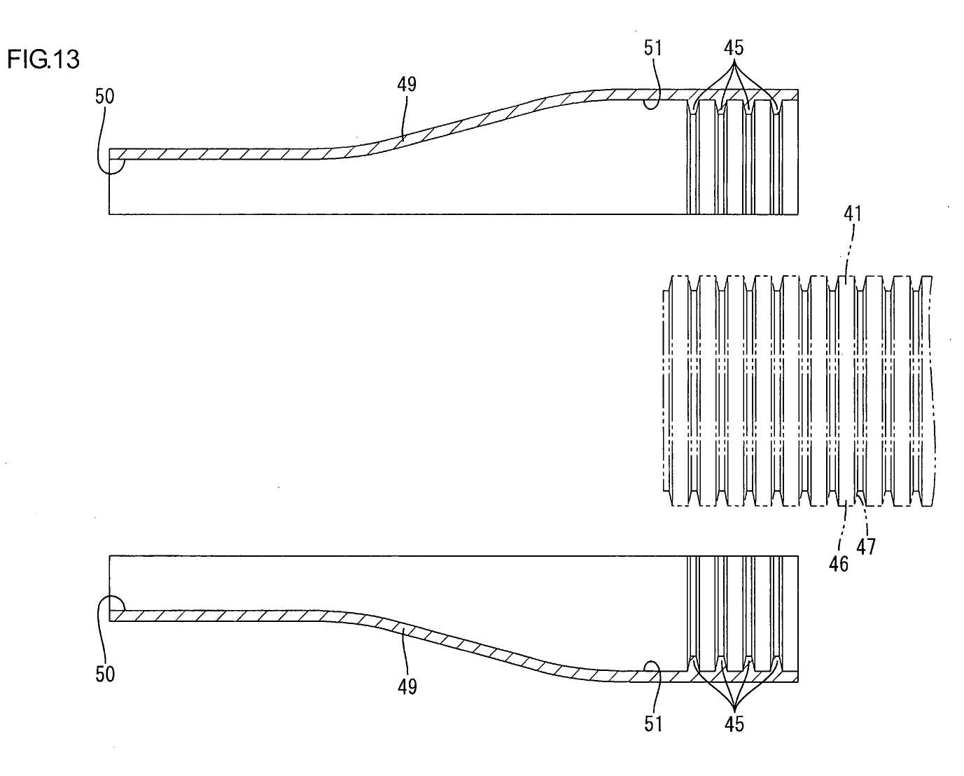

In the end of the connecting member 40 in the side of the corrugated tube 41, a third housing member 44 to be connected with the corrugated tube 41 is formed. As shown in FIG. 3, the wires 13 enwrapped by the braided wire 12 are collectively housed inside of the third housing member 44. The internal diameter of the third housing member 44 is designed so as to be capable of externally fitting to the outer circumference of the corrugated tube 41. On the inner circumferential surface of the third housing member 44, in the right end in FIG. 13, a plurality (four in the present embodiment) of engagement ribs 45 capable of engaging with the corrugated tube 41 is provided, so as to protrude inwardly in the radial direction while extending in a circumferential direction of the third housing member 44. The protruding height of the engagement rib 45 from the inner circumferential surface of the third housing member 44 is designed so as to be nearly the same as the difference between the heights of the protrusion 46 and the groove 47 in the later described corrugated tube 41.

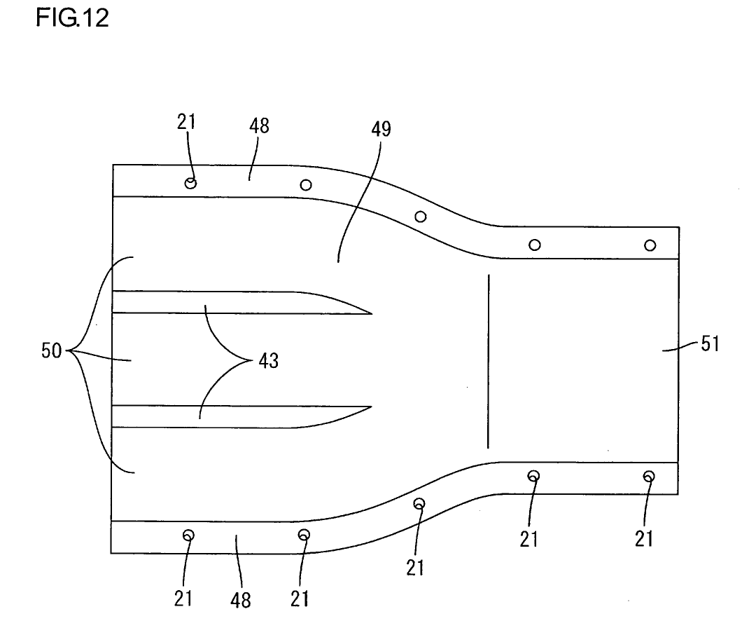

Three second housing members 42 are joined into one in the vicinity of the center in the right and left direction in FIG. 12, and the right side from this joint part is continued to the third housing member 44.

As shown in FIG. 12, a pair of ears 48 protruding up and down is provided in both the up and down side fringes of the connecting member 40 in FIG. 12. In the ears 48, a plurality of the insertion holes 21 for inserting the above-mentioned pin 22 is formed in a row at intervals so as to penetrate through the connecting member 40. A step part 56 for receiving the opposing wall 20 in the sleeve pipe 11 is formed in the ear 48.

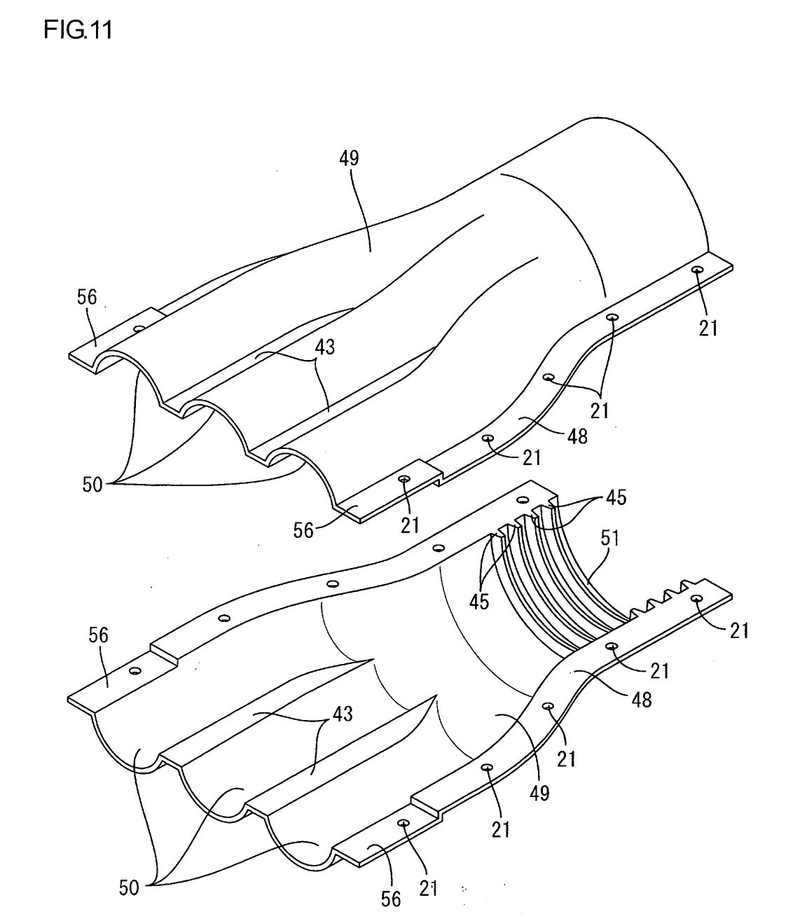

As shown in FIG. 11, the connecting member 40 is constituted by vertically joining a pair of half-split bodies 49 made of synthetic resin. In the half-split body 49, in the left end in FIG. 12, three first arcuate parts 50 of semicircular cross-section are formed in a row. In the half-split body 49, in the right end in FIG. 12, one second arcuate part 51 of semicircular cross-section is formed. Joining a pair of the half-split bodies 49 in a vertically reversed state forms the connecting member 40.

The first arcuate parts 50 are joined so as to form the second housing member 42. Also, the second arcuate parts 51 are joined so as to form the third housing member 44.

The pin 22 is inserted into the insertion hole 21 in a joined state of the half-split bodies 49, so as to press the half-split bodies 49 from above and below and fix the same. The aspect of fixing the half-split bodies 49 with the pin 22 is the same as that of fixing the above-mentioned sleeve pipe 11, so the explanation is omitted.

The hollow inside of three second housing members 42 and the hollow inside of the third housing member 44 communicate mutually, so that the wires 13 and the braided wire 12 can be arranged across from the second housing member 42 to the third housing member 44.

(Corrugated Tube)

The corrugated tube 41 is made of synthetic resin, and constituted in an accordion shape in which a protrusion 46 protruding in the radial direction and arranged along the circumferential direction and a groove 47 recessed in the radial direction and arranged along the circumferential direction are alternately continued. With this accordion shape, the corrugated tube 41 is capable of elastic deformation at will. In the corrugated tube 41, a split groove 52 along the length direction is formed across its entire length. The corrugated tube 41 can keep its cylindrical shape with the split groove 52 closed due to its elastic restoring force.

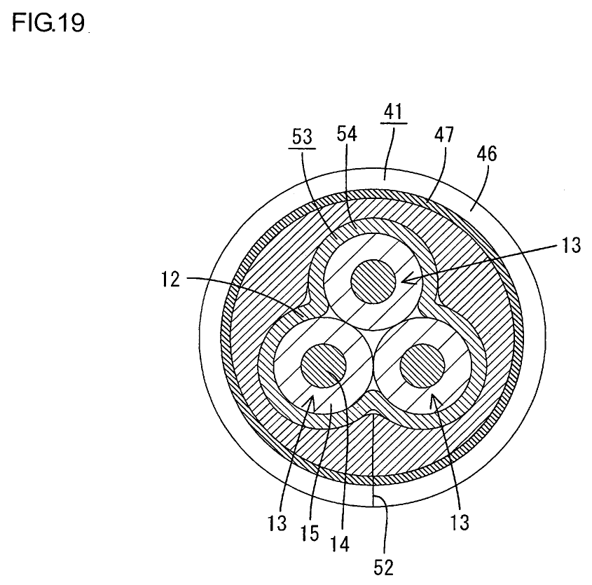

As shown in FIG. 19, three wires 13 enwrapped by the braided wire 12 are collectively housed inside of the corrugated tube 41. Three wires inside of the corrugated tube 41 are arranged in a manner that the central axes of each wire 13 form nearly an equilateral triangle.

(Bag Member)

As shown in FIG. 1, a bag member 53 having flexibility and made of synthetic resin is housed inside of the corrugated tube 41. The bag member 53 is arranged in a position between the braided wire 12 and the inner circumference of the corrugated tube 41. The bag member 53 is hollow, and inside thereof is filled with a heat conductive material 54 having a heat conductivity higher than the air. As the heat conductive material 54, any materials having a heat conductivity higher than the air may be used, such as liquid such as water and cooling oil, materials having viscosity such as silicon grease and glycerin, powder materials such as silica powder and alumina powder, and resin pellet.

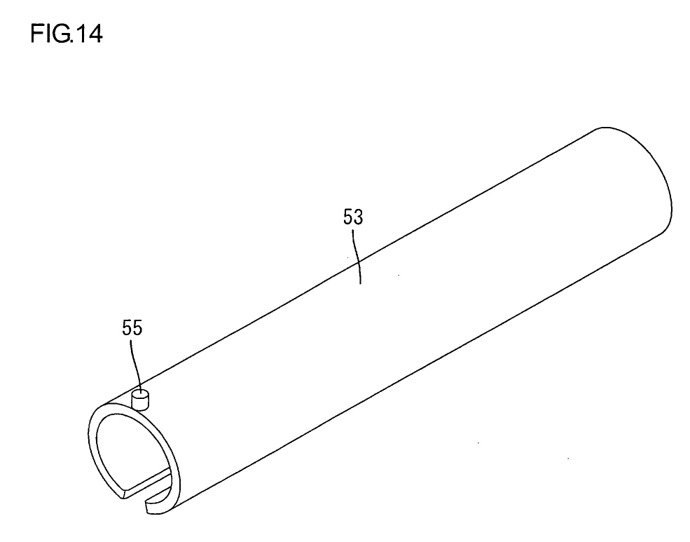

As shown in FIG. 14, the bag member 53 forms a thin and long baglike shape. In the left front end of the bag member 53 in FIG. 14, a filling inlet 55 for filling the heat conductive material 54 into the bag member 53 is protrusively provided. After filling the heat conductive material 54, the filling inlet 55 is sealed by, for example, heat sealing. The bag member 53 is capable of deformation at will when in a state filled with the heat conductive material 54 due to its flexibility.

The volume of the bag member 53 filled with the heat conductive material 54 is set to be larger than the one obtained by deducting the volume of the braided wire 12 and the wire 13 housed inside of the corrugated tube 41 from the capacity of the corrugated tube 41.

As shown in FIG. 3, in a state where the third housing member 44 in the connecting member 40 is externally fitted to the outer circumference of the corrugated tube 41, the inner circumference of the third housing member 44 presses the corrugated tube 41 radially inward thereof. The inner circumference of the corrugated tube 41 presses the bag member 53 radially inward of the corrugated tube 41. As mentioned above, the bag member 53 has flexibility and therefore deforms so as to fill the clearance between the corrugated tube 41 and the braided wire 12. This enables the bag member 53 to tightly adhere to the inner circumferential surface of the corrugated tube 41 and the outer circumferential surface of the braided wire 12. As shown in FIG. 1, the length of the bag member 53 is designed to be longer than that of the corrugated tube 41. In the bag member 53, the portions sticking out from both the right and left ends of the corrugated tube 41 in FIG. 1 are housed inside of the third housing member 44 in the connecting member 40.

The bag member 53 is pressing the braided wire 12 radially inward of the corrugated tube 41. Accordingly, the braided wire 12 having flexibility deforms so as to follow the shape of the outer circumference of the wire 13 as shown in FIG. 3. As a result, the braided wire 12 tightly adheres to the outer circumference of the wire 13.

Next, a manufacturing method of the shield conductor 10 according to the present embodiment is described. Firstly, the plate member 17 is formed by extruding a synthetic resin as shown in FIG. 5. The insertion hole 21 formed in the opposing wall 20 may be shaped at the time of extrusion, or be shaped by punching with a jig not shown after forming the plate member 17.

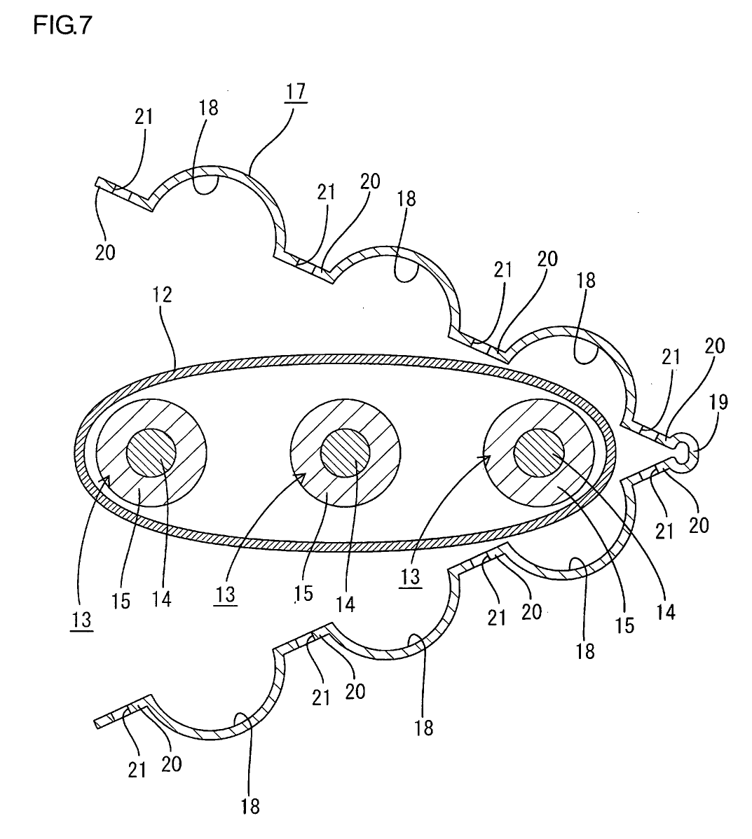

Next, as shown in FIG. 7, the wire 13 is run through inside of the braided wire 12. After that, the plate member 17 is folded at the folding member 19 so as to hold the wire 13 and the braided wire 12.

When the plate member 17 is folded at the folding member 19, the first housing member 16 is formed by the grooves 18 formed in the plate member 17. The plate member 17 is folded so as to separately house the wire 13 within this first housing member 16.

After that, as shown in FIG. 9B, the pin 22 is inserted into the insertion hole 21 in the opposing wall 20. From above the insertion hole 21 that is vertically communicating, the pin 22 is pushed downwardly, with its flat part 24 faced upward. When the lower part of the shaft part 23 is inserted into the insertion hole 21, the fall-out preventing piece 25 provided in a position closer to the lower end of the shaft part 23 is pressed by the inner circumferential surface of the insertion hole 21, and thereby elastically deforming in the closing direction of a pair of the fall-out preventing pieces 25. When the pin 22 is further pushed downwardly, a pair of the fall-out preventing pieces 25 deforms in a recovering manner in its opening direction. Then, the bottom surface of the flat part 24 of the pin 22 and the upper surface of the opposing wall 20 positioned upper side are abutted on each other from above and below, while the upper end of the fall-out preventing piece 25 and the bottom surface of the opposing wall 20 positioned lower side are abutted on each other from above and below (see FIG. 9C). This holds the opposing wall 20 between the flat part 24 and the fall-out preventing piece 25 in the pin 22. The opposing wall 20 is pressed vertically in FIG. 8 due to the elastic repulsive force of the fall-out preventing piece 25. Accordingly, the plate member 17 is fixed in a prevented-state of opening deformation in up and down direction.

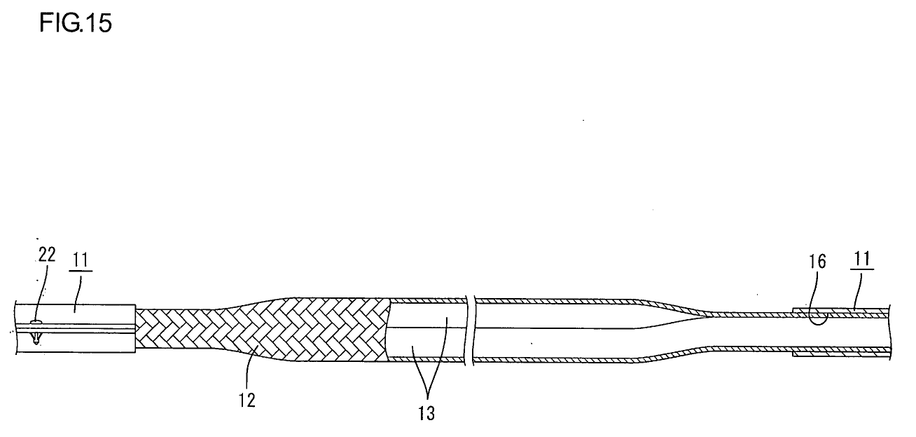

As shown in FIG. 15, the wires 13 extending from the end of the sleeve pipe 11 are arranged such that the axes of each wire 13 form a nearly equilateral triangle in a state enwrapped by the braided wire 12.

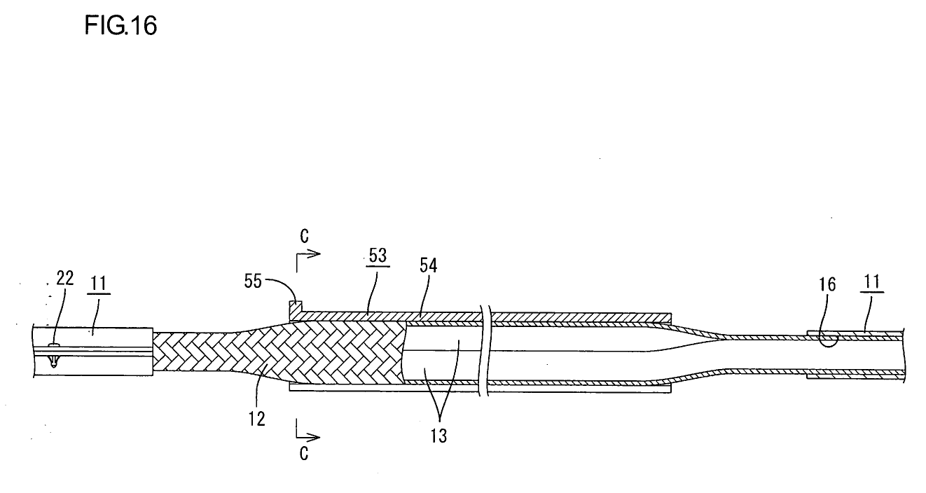

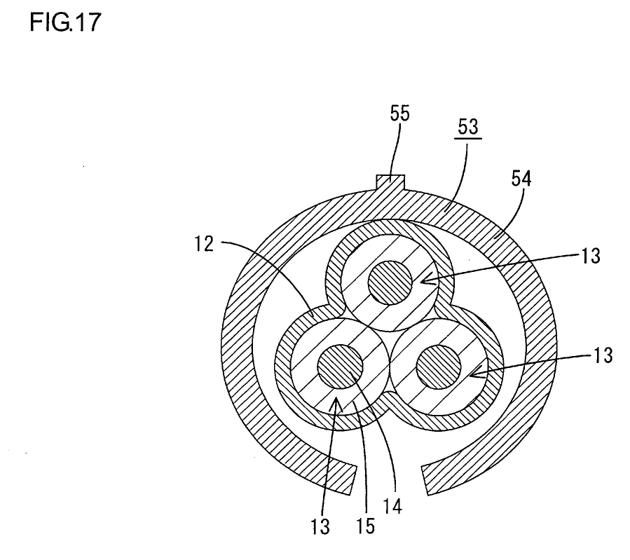

On the other hand, the inside of the bag member 53 is filled with the heat conductive material 54 from the filling inlet 55 in the bag member 53, and after that, the filling inlet 55 is sealed by for example heat sealing. The filling inlet 55 may be sealed by an adhesive. After that, as shown in FIGS. 16 and 17, the bag member 53 is arranged so as to enwrap the outer circumference of the wires 13 and the braided wire 12.

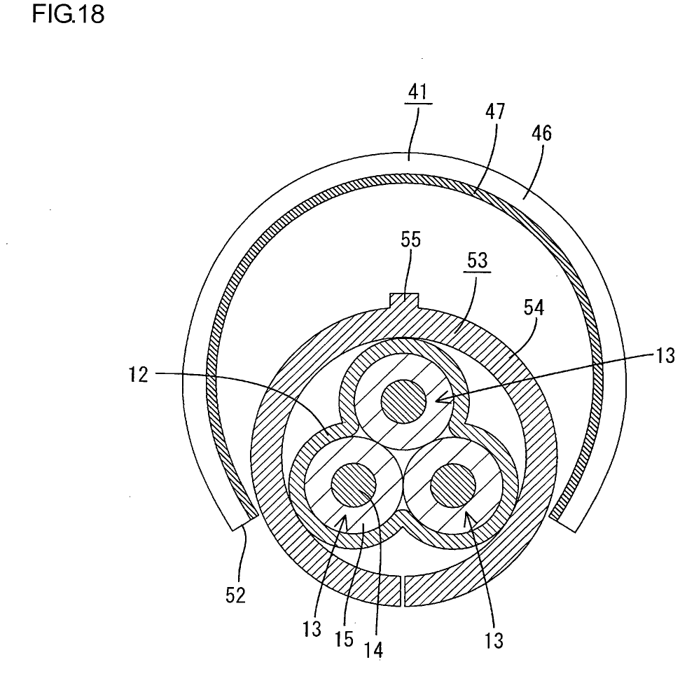

As shown in FIG. 18, in a state where the bag member 53 is arranged on the circumference of the wires 13 and the braided wire 12, a clearance occurs between the braided wire 12 and the bag member 53. In this state, the split groove 52 in the corrugated tube 41 is opened so that the corrugated tube 41 is fitted in a manner so as to enwrap the outer circumference of the bag member 53. Then, the split groove 52 closes due to the elastic restoring force of the corrugated tube 41. As shown in FIG. 19, this causes the bag member 53 to deform due to the pressure from the inner circumferential surface of the corrugated tube 41, the inner circumferential surface of the corrugated tube 41 and the bag member 53 to tightly adhere each other, and the bag member 53 and the outer circumferential surface of the braided wire to tightly adhere each other. Furthermore, the braided wire 12 and the outer circumferential surface of the wire 13 adhere tightly each other.

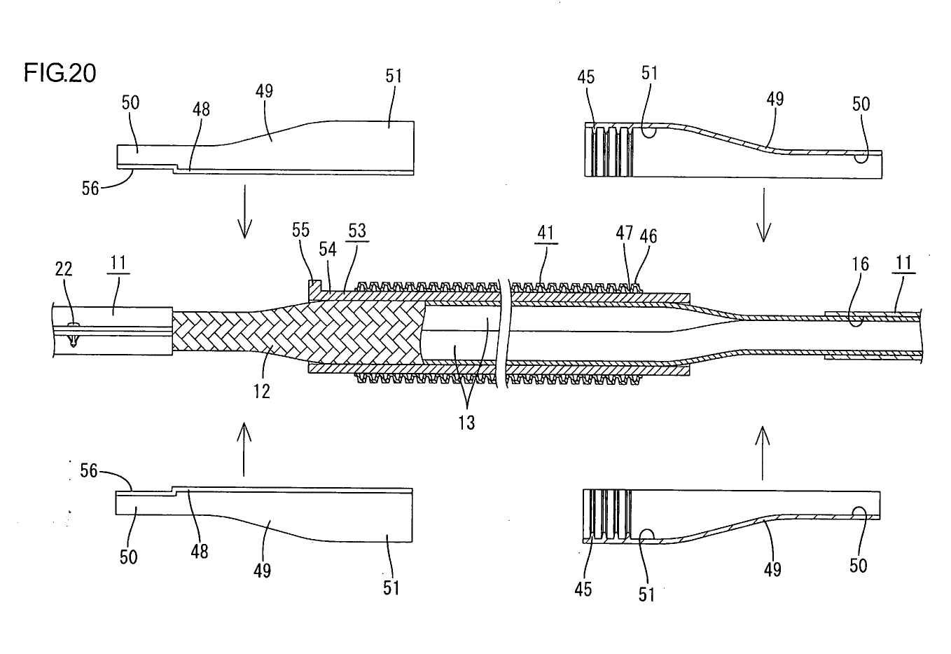

After that, as shown in FIG. 20, a pair of the half-split bodies 49 is combined from above and below in both the right and left ends of the corrugated tube 41 in FIG. 20. Here, three first arcuate parts 50 are externally fitted to the outer circumference of the corresponding first housing member 16.

Meanwhile, the second arcuate part 51 is fitted to the outer circumference of the corrugated tube 41. Here, the groove 47 in the corrugated tube 41 and the engagement rib 45 in the connecting member 40 are in a corresponding positional relationship.

In a combined state of the half-split bodies 49, the pin 22 is inserted into the insertion hole 21 formed in the ear 48. This pin 22 fixes the half-split bodies 49 by pressing from above and below in FIG. 1. Accordingly, the shield conductor 10 is completed.

According to the present invention, using the connecting member 40 enables the sleeve pipe 11, in which housing members for housing the wires 13 are arranged in a row, and the corrugated tube 41 to be easily connected. This enables the wires 13 and the braided wire 12 to be housed inside of the sleeve pipe 11 for arrangement in a relatively large space, while in a relatively narrow space, enabling the wires 13 and the braided wire 12 to be housed inside of the corrugated tube 41. Consequently, in the part using the sleeve pipe 11, the heat dissipation property of the shield conductor 10 can be improved, while in the part using the corrugated tube 41, the flexibility can be provided to the shield conductor 10.

Also, according to the present embodiment, the connecting member 40 may be formed from the half-split bodies 49 of an identical shape, and thereby achieving a cost reduction in manufacturing.

In addition, according to the present embodiment, the hollow bag member 53 made of a material having flexibility is disposed between the corrugated tube 41 and the shielding layer, and the inside thereof is filled with the heat conductive material 54 of a heat conductivity higher than the air. This allows the heat dissipation property in a section in the shield conductor 10, where the wires 13 and the braided wire 12 are housed in the corrugated tube 41, to be improved.

Furthermore, as the bag member 53 has flexibility, the inner circumferential surface of the corrugated tube 41 presses and deforms the bag member 53, so that the inner circumferential surface of the corrugated tube 41 and the bag member 53 come into a tight contact. And, as the braided wire 12 also has flexibility, the bag member 53 presses and deforms the braided wire 12, so that the bag member 53 and the braided wire 12 come into a tight contact. Furthermore, being pressed by the bag member 53 causes the braided wire 12 to tightly adhere to the circumferential surface of the wire 13. With this configuration, the heat generated from the wire 13 is transmitted sequentially from the outer circumferential surface of the wire 13, to the braided wire 12, the bag member 53, and to the inner circumferential surface of the corrugated tube 41, and then is released from the outer circumference of the corrugated tube 41 to the outside of the shield conductor. Consequently, the heat dissipation property of the area housed in the corrugated tube 41 in the shield conductor 10 can be further improved.

### Other Embodiments

With embodiments of the present invention described above with reference to the accompanying drawings, it is to be understood that the invention is not limited to those precise embodiments, and the embodiments as below, for example, can be within the scope of the present invention.

(1) The braided wire 12 collectively enwraps multiple wires 13, however, each wire 13 may be separately enwrapped by the braided wire 12.
(2) In the present embodiment, the shield conductor 10 includes three wires 13, however, the present invention is not limited to this, and multiple wires 13, two or four and more, may be included.
(3) A pair of half-split bodies 49 composing the connecting member 40 may have different shapes.
(4) When the heating value of the wires 13 is relatively small, the bag member 53 may be omitted.
(5) In the present embodiment, the shielding layer is represented by the braided wire 12, however, the present invention is not limited to this, and any materials having flexibility and shielding property, for example, such as an aluminum sheet material and a tape material may be used.
(6) In the present embodiment, the sleeve pipe 11 is constituted by folding one plate member 17, however, the present invention is not limited to this, and the sleeve pipe 11 may be constituted by overlapping a pair of plate members. In this case, the pair of plate members may be made of the same synthetic resin, or, one plate member may be made of a synthetic resin, while the other be made of a metallic material.
(7) In the present embodiment, the connecting member 40 is formed by combining a pair of half-split bodies 49 made of the same synthetic resin, however, the present invention is not limited to this, and one half-split body 49 may be made of a synthetic resin, while the other be made of a metallic material.
(8) As means for composing the sleeve pipe 11 by fixing the plate member 17, for example, a rivet may be used, and moreover, any members capable of pressing the inner circumference of the sleeve pipe 11 toward the outer circumference of the wire 13 may be used. Additionally, the plate member 17 may be combined and fixed with heat sealing or an adhesive.

Like the above, as means for composing the connecting member 40 by fixing the half-split bodies 49 each other, for example, a rivet may be used, and moreover, any members capable of pressing the inner circumference of the connecting member 40 toward the outer circumference of the wire 13 may be used. Additionally, the half-split bodies 49 may be combined and fixed each other with heat sealing or an adhesive.

1-4. (canceled)

5. A shield conductor comprising:
multiple wires;
a shielding layer enwrapping the outer circumference of the wires while having flexibility;
a sleeve pipe having multiple first housing members that are arranged in a row in a direction orthogonal to the axial direction of the wires and separately house the wires enwrapped by the shielding layer;
a connecting member having multiple second housing members that are connected with each first housing member in the sleeve pipe and separately house the wires enwrapped by the shielding layer, while having a third housing member that is communicated with each second housing member and collectively houses the wires enwrapped by the shielding layer; and
a corrugated tube connected with the third housing member in the connecting member and collectively housing the wires enwrapped by the shielding layer.

6. The shield conductor according to claim 5, wherein the connecting member is constituted by combining a pair of half-split bodies, each half-split body comprises multiple first arcuate parts composing the second housing member and a second arcuate part composing the third housing member, and the cross-sectional shape of the first and the second arcuate parts are semicircular.

7. The shield conductor according to claim 6, wherein a hollow bag member made of a material having flexibility is disposed between the corrugated tube and the shielding layer, and the inside of the bag member is filled with a heat conductive material having a heat conductivity higher than the air.

8. The shield conductor according to claim 7, wherein an inner circumferential surface of the corrugated tube contacts with the bag member and presses the same in a radially inward direction of the corrugated tube, the bag member contacts with the shielding layer and presses the same in the radially inward direction, and the shielding layer contacts with the outer circumferential surface of the wire and presses the circumferential surface of the same in the radially inward direction.

9. The shield conductor according to claim 5, wherein a hollow bag member made of a material having flexibility is disposed between the corrugated tube and the shielding layer, and the inside of the bag member is filled with a heat conductive material having a heat conductivity higher than the air.

10. The shield conductor according to claim 9, wherein an inner circumferential surface of the corrugated tube contacts with the bag member and presses the same in a radially inward direction of the corrugated tube, the bag member contacts with the shielding layer and presses the same in the radially inward direction, and the shielding layer contacts with the outer circumferential surface of the wire and presses the circumferential surface of the same in the radially inward direction.
